(19) United States
(12) Patent Application Publication
(10) Pub. No.: US 2024/0067580 A1
(43) Pub. Date: Feb. 29, 2024

(54) SYSTEM AND METHOD FOR CONVERTING BIOMASS ASH MATERIAL INTO FERTILIZER

(71) Applicant: Blue Reason, LLC, St. Louis, MO (US)

(72) Inventor: Samuel Vanderpool, St. Louis, MO (US)

(21) Appl. No.: 18/454,769

(22) Filed: Aug. 23, 2023

Related U.S. Application Data
(60) Provisional application No. 63/400,191, filed on Aug. 23, 2022.

(51) Int. Cl. C05B 13/02

(52) U.S. Cl. CPC C05B 13/02

(57) ABSTRACT

A method is provided herein for developing fertilizer that may include the steps of combining a source of micronutrients with at least a first nitrogen source, a first phosphorus source, a first potassium source, or a first additional source. The first source of micronutrients may be derived from the combustion of a biomass feedstock via a biomass combustion system. The first source of micronutrients may comprise, for example, a biomass ash or a wood ash. The fertilizer may be organic or inorganic and may be used for a variety of purposes. The fertilizer may be in powder, granular, or pelletized form.

### CROSS-REFERENCE TO RELATED APPLICATIONS

The present application claims priority to U.S. Provisional Patent Application No. 63/400,191 entitled “System and Method for Converting Biomass Ash Material into Fertilizer,” filed Aug. 23, 2022, currently pending, the entire disclosure, including the specification and drawings, of which is incorporated herein by reference.

### FIELD OF INVENTION

The present invention relates generally to a system and method for converting byproduct into fertilizer. More specifically, the invention relates to a system and method for converting biomass ash material from biomass-fueled power plants into organic fertilizer.

### BACKGROUND OF INVENTION

Current systems and methods for developing fertilizer require extensive mining and extraction. Oftentimes, the extraction of these materials to generate fertilizer is harmful to the environment. After extraction is completed and fertilizer is produced, there is leftover byproduct. The fertilizer producers then must dispose of their byproducts, causing further environmental harm. Such byproduct is not utilized and goes to waste.

Moreover, the extraction and generation of fertilizer occurs in various countries. After it is produced, the fertilizer must be transported to other areas that utilize the fertilizer. Not only is the extraction potentially harmful, but also, the transportation of the generated fertilizer contributes to the harm of the environment. Additionally, countries who produce and export large quantities of fertilizer have particular influence over the price and market. When unrest occurs in the world, the transportation and price of fertilizer may be affected.

### SUMMARY OF INVENTION

The present invention overcomes many of the shortcomings and limitations of the prior art discussed above. The invention described herein includes several embodiments of a system and method for converting byproduct into fertilizer.

It is common for biomass-fueled power plants to burn various forms of waste to produce steam in order to produce electricity. Byproducts are inherently made when this waste is burned. In current systems, these byproducts are underutilized. However, the present disclosure provides a system and method for utilizing these byproducts. Byproducts from biomass-fueled power plants and other waste from various facilities can be combined to produce organic fertilizer.

Additionally, the system and method can be used in conjunction with any biomass-fueled power plant. Because the fertilizer can be produced locally, the need for transportation, and the costs associated therewith, goes down. Another benefit is the elimination of byproducts filling the landfills. The fertilizer contributes to sustainability: it is organic, fully recycled, and a direct source from renewable energy.

### BRIEF DESCRIPTION OF DRAWINGS

FIG. 1 is an illustrative diagram for the development of fertilizer in accordance with one embodiment of the present invention.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be appreciated that any dimensions included in the drawing FIGURES are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

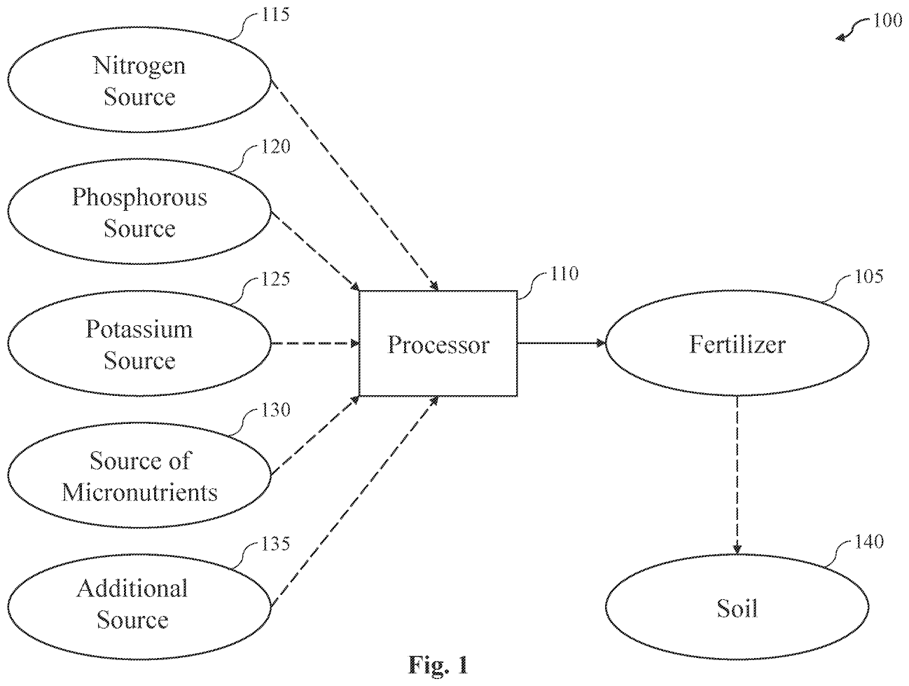

FIG. 1 is an illustrative diagram 100 for the development of fertilizer 105. In one embodiment, the fertilizer 105 is made from combining any of the following via a processor 110: nitrogen source 115, phosphorus source 120, potassium source 125, source of micronutrients 130, and additional source 135. The different sources may be selected in any manner to achieve a particular result. According to one embodiment, the following sources and ingredients may be used in an organic retail environment. It will be appreciated that the nitrogen-phosphorus-potassium (N—P—K) and other levels, ratios, and percentages provided herein, including with respect to the various sources (e.g., nitrogen sources 115, phosphorus sources 120, potassium sources 125, sources of micronutrients 130, and additional sources 135) are provided as non-limiting examples, are approximations, and may be in a range that encompasses percentages that are greater than or less than those example percentages listed herein.

According to various embodiments, the nitrogen source 115 may be any nitrogen source known in the art. The following non-limiting examples may be used as the nitrogen source 115: cottonseed meal (6% nitrogen, 2% phosphorus, 1% potassium), feather meal (13% nitrogen, 0% phosphorus, 0% potassium), blood meal (12% nitrogen, 0% phosphorus, 0% potassium), alfalfa meal (3% nitrogen, 1% phosphorus, 2% potassium), fish meal (10% nitrogen, 4% phosphorus, 0% potassium), crab meal (4% nitrogen, 3% phosphorus, 0% potassium), meat meal (8% nitrogen, 5% phosphorus, 0% potassium, 10% calcium), soybean meal (7% nitrogen, 1.5% phosphorus, 1% potassium), neem seed meal (6% nitrogen, 2% phosphorus, 1% potassium), corn gluten (9% nitrogen, 0% phosphorus, 0% potassium), and porcine blood meal (15% nitrogen, 0% phosphorus, 1% potassium). The alfalfa meal, soybean meal, and neem seed meal may be preferred in vegan environments. According to various embodiments, the nitrogen source 115 may be a byproduct from food or livestock processing facilities. In one embodiment, this byproduct is feather meal from processing poultry. As discussed above, this byproduct may also be bone meal, fish meal, blood meal, or any other suitable nitrogen-containing product or byproduct. Feather meal is typically high in nitrogen. Because the feather meal has a low calcium carbonate equivalency, it may be used to offset neutralization of acidic or basic soil by lowering the liming effect from raising the soil's pH levels from ash. In one embodiment, the feather meal can slowly release into the soil.

According to various embodiments, the phosphorus source 120 may be any phosphorus source known in the art. The following non-limiting examples may be used as the phosphorus source 120: fishbone meal (4% nitrogen, 12% phosphorus, 0% potassium), rock phosphate (0% nitrogen, 20% phosphorus, 1.5% potassium), shrimp meal (6% nitrogen, 6% phosphorus, 0% potassium), seabird guano (0% nitrogen, 11% phosphorus, 0% potassium), and bone meal (3% nitrogen, 15% phosphorus, 0% potassium). The rock phosphate may be preferred in vegan environments.

According to various embodiments, the potassium source 125 may be any potassium source known in the art. The following non-limiting examples may be used as the potassium source 125: langbeinite (0% nitrogen, 0% phosphorus, 22% potassium), kelp meal (1% nitrogen, 0% phosphorus, 4% potassium), sulphate of potash (0% nitrogen, 0% phosphorus, 50% potassium, 18% sulfur), and greensand (0% nitrogen, 0% phosphorus, 3% potassium). The langbeinite, kelp meal, and greensand may be preferred in vegan environments.

According to various embodiments, the source of micronutrients 130 may be any source of micronutrients known in the art. The following non-limiting examples may be used as the source of micronutrients 130: basalt rock mineral, zinc sulphate, oyster shells, poultry manure, wood ash, and elemental sulfur.

According to one embodiment, the source of micronutrients 130 may be byproduct from a biomass-fired power plant (e.g., ash from a wood-fired power plant). Ash is typically high in micronutrients and potassium and low in nitrogen. Additionally, ash typically has a lower calcium carbonate equivalency and a high potential of hydrogen (pH) level, which can help neutralize acidic soil by raising the soil's pH levels. In one embodiment, the ash is supplied to the soil to nourish plants and the microbiota in the soil.

The ash may be derived from the combustion of a biomass feedstock. The biomass feedstock may be developed from: dedicated energy crops, agricultural crop residue, forestry residue, algae, wood processing residues, municipal waste, and wet waste. Such dedicated energy crops may be switchgrass, miscanthus, bamboo, sweet sorghum, tall fescue, kochia, wheatgrass, hybrid poplar, hybrid willow, silver maple, eastern cottonwood, green ash, black walnut, sweetgum, white oak, and sycamore. Such agricultural crop residue may be corn stover (e.g., stalks, leaves, husks, and cobs), wheat straw, oat straw, barley straw, sorghum stubble, and rice straw. Such forestry residue may be limbs, tops, and culled trees and tree components (which may be otherwise unmerchantable). Such algae may be microalgae, macroalgae (also called seaweed), and cyanobacteria. Such wood processing residues may be unused sawdust, bark, branches, leaves, and tree needles. Such wet waste may be: commercial, institutional, and residential food wastes (which may currently be disposed of in landfills), organic-rich biosolids (e.g., treated sewage sludge from municipal wastewater), manure slurries from concentrated livestock operations, organic wastes from industrial operations, and biogas derived from any of the aforementioned feedstock streams (e.g., the gaseous product of the decomposition of organic matter in the absence of oxygen). The biomass combustion systems that may produce such biomass feedstock may be a fixed bed system, a fluidized bed system, and a biomass gasification system. The foregoing examples are for exemplary purposes only and shall not be construed as limiting.

According to various embodiments, the following non-limiting examples may be used as the additional source 135: Earthworm castings (2% nitrogen, 1% phosphorus, 1% potassium), calcium carbonate, dolomitic limestone, wood ash (0% nitrogen, 1% phosphorus, 3% potassium), gypsum, diatomaceous Earth, chicken manure (1.1% nitrogen, 0.8% phosphorus, 0.5% potassium), cow manure (3% nitrogen, 2% phosphorus, 1% potassium), fish emulsion (4% nitrogen, 1% phosphorus, 1% potassium), egg shells, coffee grounds, swine manure (0.6% nitrogen, 0.4% phosphorus, 0.3% potassium), bat guano (8% nitrogen, 5% phosphorus, 1.5% potassium), horse manure (0.7% nitrogen, 0.3% phosphorus, 0.6% potassium), sheep manure (0.7% nitrogen, 0.3% phosphorus, 0.9% potassium), goat manure (0.7% nitrogen, 0.3% phosphorus, 0.9% potassium), biosolids (10.15% nitrogen, 1% phosphorus), and corn steep liquor.

According to one embodiment, the following sources and ingredients may be used in an inorganic agriculture and retail environment. According to various embodiments, the nitrogen source 115 may be any nitrogen source known in the art. The following non-limiting examples may be used as the nitrogen source 115: urea (46% nitrogen, 0% phosphorus, 0% potassium), ammonium nitrate (34% nitrogen, 0% phosphorus, 0% potassium), ammonium sulphate (20% nitrogen, 0% phosphorus, 0% potassium, 24% sulfur), calcium nitrate (15.5% nitrogen, 0% phosphorus, 0% potassium, 19% calcium), nitrate, ammonia, cal-nitro (ammonium nitrate with limestone), anhydrous ammonia (82% nitrogen), and aqua ammonia.

According to various embodiments, the phosphorus source 120 may be any phosphorus source known in the art. The following non-limiting examples may be used as the phosphorus source 120: diammonium phosphate (18% nitrogen, 46% phosphorus, 0% potassium), monoammonium phosphate (12% nitrogen, 52% phosphorus, 0% potassium), triple super phosphate (0% nitrogen, 46% phosphorus, 0% potassium), and super phosphate (0% nitrogen, 20% phosphorus, 0% potassium).

According to various embodiments, the potassium source 125 may be any potassium source known in the art. The following non-limiting examples may be used as the potassium source 125: potassium nitrate, also called nitrate of potash (13% nitrogen, 0% phosphorus, 44% potassium), potassium chloride, also called muriate of potash (0% nitrogen, 0% phosphorus, 60% potassium), and potassium sulphate (0% nitrogen, 0% phosphorus, 50% potassium, 46% sulfur).

According to various embodiments, the following non-limiting examples may be used as the additional source 135 on farm fertilizer application methods: broadcasting, banding, foliar application, drip irrigation, seed treatment, side-dressing, and control release. According to various embodiments, the additional source 135 may be provided in a liquid, powder (e.g., raw ash), granular, or pelletized form.

According to various embodiments, the fertilizer 105 may be provided in a powder, granular, or pelletized form. In one embodiment, the powdered fertilizer provides a faster release of nutrients into the plants. This faster release allows for the nutrients to be provided to the soil over a longer period of time. In one embodiment, the granular fertilizer provides a slow release of nutrients into the plants. This slow release allows for the nutrients to be provided to the soil over a longer period of time. In one embodiment, the fertilizer 105 may be in a pelletized form. According to one embodiment, the pelletized fertilizer provides a slow release of nutrients into the plants. In one embodiment, this slow release is slower than the slow release of the aforementioned slow release of the granular fertilizer. This slow release allows for the nutrients to be provided to the soil over a longer period of time. According to various embodiments, the pelletized fertilizer may break down at a slower rate than the powdered fertilizer.

According to various embodiments, the aforementioned sources may be combined using a processor 110. In one embodiment, the processor 110 is configured to process the nitrogen source 115, phosphorus source 120, potassium source 125, source of micronutrients 130, and/or additional source 135 into fertilizer 105.

According to various embodiments, the fertilizer 105 provides necessary nutrients to the targeted plants in the soil. In one embodiment, the fertilizer 105 supports sustainability by being fully recycled. Additionally, the fertilizer 105 may be fully organic and is more easily absorbed by plants. The fertilizer 105 may be used in agricultural applications for farming or consumer applications for home and garden. In the consumer context, current fertilizers are not fully recycled and fully organic while also supporting the renewable energy industry. However, the present disclosure can overcome this limitation.

The fertilizer 105 may be used as a compost amendment to adjust the pH levels of the soil, for microbial enhancement, and for nutritional value enhancement. According to various embodiments, the fertilizer 105 may be used to develop soil 140; for example, it may be used as topsoil, raised bed soil, potting soil, soil amendment, or any other form of soil that may be used as a medium in which a plant can grow. The fertilizer 105 may be used as a poultry dust bath in order to clean feathers and/or kill mites and parasites; in such an embodiment, the fertilizer 105 may also reduce odors in a coup.

The fertilizer 105, regardless of its form, can be applied without the use of a specific tool. Rather, according to various embodiments, the fertilizer 105 can be applied with any agricultural spreading tool. In one embodiment, the fertilizer 105 is applied on top of the soil. In one embodiment, the fertilizer 105 is mixed into the soil to further spread it.

As illustrated in the tables provided below, the fertilizer 105 may raise the soil's pH levels and may be used to enhance the nutritional value of the soil where the fertilizer 105 is applied. The fertilizer 105 as provided herein produces unexpected results due to its unique formulation, and the fertilizer 105 may be customized in a variety of different ways (as discussed above) in order to achieve specific results.

TABLE 1
50% feather meal combined with 50% wood ash

| | | Desired | | Interpretation | | |
|---|---|---|---|---|---|---|
| Tests | Units | Range | Results | Low | Desired | High |
| pH | | 6.0-8.0 | 12.3 | | | x |
| E.C.-Saturation | mmho/cm | <4 | 8.74 | | | x |
| Paste | | | | | | |
| Nitrate-N | ppm | [symbol] | | | | |
| (NO₃—N) [symbol] | | | | | | |
| Ammonium-N | ppm | | | | | |
| (NH₄—N) [symbol] | | | | | | |
| Chloride (Cl) | ppm | 117 | | | | |
| Moisture | % | [symbol] 50 | [symbol] | | x | |
| C/N Ratio | | <25 | 3.76 | | x | |

| Tests | Units | Wet Weight Basis |
|---|---|---|
| Total Nitrogen (N) | % | [symbol] |
| | N lbs/Ton | [symbol] |
| Total Phosphorus (P) | % | 0.287 |
| | P₂O [symbol] lbs/Ton | 13.2 |
| Total Potassium (K) | % | [symbol] |
| | K₂O lbs/Ton | [symbol] |
| Total Calcium (Ca) | % | 8.28 |
| Total Magnesium (Mg) | % | [symbol] |
| Total Zinc (Zn) | ppm | 111 |
| Total Iron (Fe) | ppm | [symbol] |
| Total Manganese (Mn) | ppm | [symbol] |
| Total Copper (Cu) | ppm | 24 |
| Total Carbon (C) | % | 23 |
| Ash percentage | % | |

[symbol]

Interpretation for nitrate-N is for growing media only. If this material is to be used as soil amendment, the interpretation for nitrate-N is not applicable. [symbol]
indicates data missing or illegible when filed

TABLE 2
30% feather meal combined with 70% wood ash

| | | Desired | | Interpretation | | |
|---|---|---|---|---|---|---|
| Tests | Units | Range | Results | Low | Desired | High |
| pH | | 6.0-8.0 | 12.4 | | | x |
| E.C.-Saturation | mmho/cm | [symbol] | [symbol] | | | x |
| Paste | | | | | | |
| Nitrate-N | ppm | [symbol] | | | | |
| (NO₃—N) [symbol] | | | | | | |
| Ammonium-N | ppm | | | | | |
| (NH₄—N) [symbol] | | | | | | |
| Chloride (Cl) | ppm | 117 | | | | |
| Moisture | % | <50 | 2.10 | | x | |
| C/N Ratio | | <25 | 3.97 | | x | |

| Tests | Units | Wet Weight Basis |
|---|---|---|
| Total Nitrogen (N) | % | [symbol] |
| | N lbs/Ton | 78.4 |
| Total Phosphorus (P) | % | 0.275 |
| | P₂O [symbol] lbs/Ton | [symbol] |
| Total Potassium (K) | % | [symbol] |
| | K₂O lbs/Ton | 44.6 |
| Total Calcium (Ca) | % | 11.2 |
| Total Magnesium (Mg) | % | 1.04 |
| Total Zinc (Zn) | ppm | 112 |
| Total Iron (Fe) | ppm | [symbol] |
| Total Manganese (Mn) | ppm | 1472 |
| Total Copper (Cu) | ppm | 30 |
| Total Carbon (C) | % | 16 |
| Ash percentage | % | |

[symbol]

Interpretation for nitrate-N is for growing media only. If this material is to be used as soil amendment, the interpretation for nitrate-N is not applicable. [symbol]
indicates data missing or illegible when filed

TABLE 3
70% feather meal combined with 30% wood ash

| | | Desired | | Interpretation | | |
|---|---|---|---|---|---|---|
| Tests | Units | Range | Results | Low | Desired | High |
| pH | | [symbol] | 12.2 | | | x |
| E.C.-Saturation | mmho/cm | <4 | 7.20 | | | x |
| Paste | | | | | | |
| Nitrate-N | ppm | [symbol] | | | | |
| (NO₃—N) [symbol] | | | | | | |
| Ammonium-N | ppm | | | | | |
| (NH₄—N) [symbol] | | | | | | |
| Chloride (Cl) | ppm | 117 | | | | |
| Moisture | % | <50 | 5.84 | | x | |
| C/N Ratio | | <25 | 3.67 | | x | |

| Tests | Units | Wet Weight Basis |
|---|---|---|
| Total Nitrogen (N) | % | 9.23 |
| | N lbs/Ton | 185 |
| Total Phosphorus (P) | % | 0.285 |
| | P₂O [symbol] lbs/Ton | [symbol] |
| Total Potassium (K) | % | 0.941 |
| | K₂O lbs/Ton | 21.1 |
| Total Calcium (Ca) | % | [symbol] |
| Total Magnesium (Mg) | % | 0.484 |
| Total Zinc (Zn) | ppm | [symbol] |
| Total Iron (Fe) | ppm | [symbol] |
| Total Manganese (Mn) | ppm | [symbol] |
| Total Copper (Cu) | ppm | 18 |
| Total Carbon (C) | % | 34 |
| Ash percentage | % | |

[symbol]

Interpretation for nitrate-N is for growing media only. If this material is to be used as soil amendment, the interpretation for nitrate-N is not applicable. [symbol]
indicates data missing or illegible when filed

TABLE 4
33% fish bone meal combined with
33% feather meal and 33% wood ash

| | | Desired | | Interpretation | | |
|---|---|---|---|---|---|---|
| Tests | Units | Range | Results | Low | Desired | High |
| pH | | 6.0-80 | [symbol] | | | x |
| E.C.-Saturation | mmho/cm | <4 | [symbol] | | | x |
| Paste | | | | | | |
| Nitrate-N | ppm | 40-99 | | | | |
| (NO₃—N) [symbol] | | | | | | |
| Ammonium-N | ppm | | | | | |
| (NH₄—N) [symbol] | | | | | | |
| Moisture | % | <50 | 4.76 | | x | |
| C/N Ratio | | <25 | 4.29 | | x | |

| Tests | Units | Wet Weight Basis |
|---|---|---|
| Total Nitrogen (N) | % | 3.35 |
| | N lbs/Ton | 67.1 |
| Total Phosphorus (P) | % | 2.18 |
| | P₂O [symbol] lbs/Ton | 99.7 |
| Total Potassium (K) | % | 0.621 |
| | K₂O lbs/Ton | 14.9 |
| Total Calcium (Ca) | % | 6.25 |
| Total Magnesium (Mg) | ppm | 0.244 |
| Total Zinc (Zn) | ppm | 66 |
| Total Iron (Fe) | ppm | 2052 |
| Total Manganese (Mn) | ppm | 190 |
| Total Copper (Cu) | % | 15 |
| Total Carbon (C) | | 14 |

[symbol]

Interpretation for nitrate-N is for growing media only. If this material is to be used as soil amendment, the interpretation for nitrate-N is not applicable. [symbol]
indicates data missing or illegible when filed

TABLE 5
50% fish bone meal combined with 50% wood ash

| | | Desired | | Interpretation | | |
|---|---|---|---|---|---|---|
| Tests | Units | Range | Results | Low | Desired | High |
| pH | | 6.0-8.0 | 11.8 | | | x |
| E.C.-Saturation | mmho/cm | <4 | [symbol] | | | x |
| Paste | | | | | | |
| Nitrate-N | ppm | 40-99 | | | | |
| (NO₃—N) [symbol] | | | | | | |
| Ammonium-N | ppm | | | | | |
| (NH₄—N) [symbol] | | | | | | |
| Moisture | % | <50 | [symbol] | | x | |
| C/N Ratio | | <25 | 3.74 | | x | |

| Tests | Units | Wet Weight Basis |
|---|---|---|
| Total Nitrogen (N) | % | [symbol] |
| | N lbs/Ton | 154 |
| Total Phosphorus (P) | % | 3.15 |
| | P₂O [symbol] lbs/Ton | 144 |
| Total Potassium (K) | % | 0.765 |
| | K₂O lbs/Ton | 18.4 |
| Total Calcium (Ca) | % | 9.03 |
| Total Magnesium (Mg) | ppm | 0.319 |
| Total Zinc (Zn) | ppm | 56 |
| Total Iron (Fe) | ppm | 2637 |
| Total Manganese (Mn) | ppm | 229 |
| Total Copper (Cu) | % | 14 |
| Total Carbon (C) | | 29 |

[symbol]

Interpretation for nitrate-N is for growing media only. If this material is to be used as soil amendment, the interpretation for nitrate-N is not applicable. [symbol]
indicates data missing or illegible when filed

TABLE 6
30% sewage sludge (biosolids) combined with 70% wood ash

| | | Desired | | Interpretation | | |
|---|---|---|---|---|---|---|
| Tests | Units | Range | Results | Low | Desired | High |
| pH | | [symbol] | 12.7 | | | x |
| E.C.-Saturation | mmho/cm | <4 | 15.8 | | | x |
| Paste | | | | | | |
| Nitrate-N | ppm | [symbol] | | | | |
| (NO₃—N) [symbol] | | | | | | |
| Ammonium-N | ppm | | | | | |
| (NH₄—N) [symbol] | | | | | | |
| Moisture | % | <50 | 18.1 | | x | |
| C/N Ratio | | <25 | 12.3 | | x | |

| Tests | Units | Wet Weight Basis |
|---|---|---|
| Total Nitrogen (N) | % | 0.235 |
| | N lbs/Ton | 4.71 |
| Total Phosphorus (P) | % | 0.305 |
| | P₂O [symbol] lbs/Ton | 14.1 |
| Total Potassium (K) | % | 2.05 |
| | K₂O lbs/Ton | [symbol] |
| Total Calcium (Ca) | % | [symbol] |
| Total Magnesium (Mg) | % | 1.07 |
| Total Zinc (Zn) | ppm | [symbol] |
| Total Iron (Fe) | ppm | 9141 |
| Total Manganese (Mn) | ppm | 1561 |
| Total Copper (Cu) | ppm | [symbol] |
| Total Carbon (C) | % | 3 |
| Total Sulfate (S) | ppm | 4230 |

[symbol]

indicates data missing or illegible when filed

TABLE 7
70% sewage sludge (biosolids) combined with 30% wood ash

| | | Desired | | Interpretation | | |
|---|---|---|---|---|---|---|
| Tests | Units | Range | Results | Low | Desired | High |
| pH | | [symbol] -8.0 | 12.4 | | | x |
| E.C.-Saturation | mmho/cm | <4 | 9.10 | | | x |
| Paste | | | | | | |
| Nitrate-N | ppm | [symbol] | | | | |
| (NO₃—N) [symbol] | | | | | | |
| Ammonium-N | ppm | | | | | |
| (NH₄—N) [symbol] | | | | | | |
| Moisture | % | <50 | 48.3 | | x | |
| C/N Ratio | | <25 | 9.51 | | x | |

| Tests | Units | Wet Weight Basis |
|---|---|---|
| Total Nitrogen (N) | % | [symbol] |
| | N lbs/Ton | 12.2 |
| Total Phosphorus (P) | % | 0.304 |
| | P₂O [symbol] lbs/Ton | [symbol] |
| Total Potassium (K) | % | 1.04 |
| | K₂O lbs/Ton | 23.3 |
| Total Calcium (Ca) | % | [symbol] |
| Total Magnesium (Mg) | % | [symbol] |
| Total Zinc (Zn) | ppm | [symbol] |
| Total Iron (Fe) | ppm | 8702 |
| Total Manganese (Mn) | ppm | 968 |
| Total Copper (Cu) | ppm | [symbol] |
| Total Carbon (C) | % | 6 |
| Total Sulfate (S) | ppm | [symbol] |

[symbol]

Interpretation for nitrate-N is for growing media only. If this material is to be used as soil amendment, the interpretation for nitrate-N is not applicable. [symbol]
indicates data missing or illegible when filed

TABLE 8
50% sewage sludge (biosolids) combined with 50% wood ash

| | | Desired | | Interpretation | | |
|---|---|---|---|---|---|---|
| Tests | Units | Range | Results | Low | Desired | High |
| pH | | 6.0- [symbol] | 12.6 | | | x |
| E.C.-Saturation | mmho/cm | <4 | 12.9 | | | x |
| Paste | | | | | | |
| Nitrate-N | ppm | [symbol] | | | | |
| (NO₃—N) [symbol] | | | | | | |
| Ammonium-N | ppm | | | | | |
| (NH₄—N) [symbol] | | | | | | |
| Moisture | % | <50 | 33.5 | | x | |
| C/N Ratio | | <25 | [symbol] | | x | |

| Tests | Units | Wet Weight Basis |
|---|---|---|
| Total Nitrogen (N) | % | [symbol] |
| | N lbs/Ton | [symbol] |
| Total Phosphorus (P) | % | 0.345 |
| | P₂O [symbol] lbs/Ton | 15.5 |
| Total Potassium (K) | % | 1.47 |
| | K₂O lbs/Ton | 32.9 |
| Total Calcium (Ca) | % | 8.51 |
| Total Magnesium (Mg) | % | 0.802 |
| Total Zinc (Zn) | ppm | [symbol] |
| Total Iron (Fe) | ppm | 7727 |
| Total Manganese (Mn) | ppm | 1224 |
| Total Copper (Cu) | ppm | 90 |
| Total Carbon (C) | % | 4 |
| Total Sulfate (S) | ppm | 4529 |

[symbol]

Interpretation for nitrate-N is for growing media only. If this material is to be used as soil amendment, the interpretation for nitrate-N is not applicable. [symbol]
indicates data missing or illegible when filed

TABLE 9
wood ash (control)

| | | Desired | | Interpretation | | |
|---|---|---|---|---|---|---|
| Tests | Units | Range | Results | Low | Desired | High |
| pH | | [symbol] | 12.7 | | | x |
| E.C.-Saturation | mmho/cm | <4 | 34.9 | | | x |
| Paste | | | | | | |
| Nitrate-N | ppm | 40-99 | 45.9 | | x | |
| (NO₃—N) [symbol] | | | | | | |
| Ammonium-N | ppm | | 1.36 | | | |
| (NH₄—N) [symbol] | | | | | | |
| Moisture | % | <50 | [symbol] | | x | |
| C/N Ratio | | <25 | 23.5 | | x | |

| Tests | Units | Wet Weight Basis |
|---|---|---|
| Total Nitrogen (N) | % | 0.013 |
| Total Phosphorus (P) | % | [symbol] |
| Total Potassium (K) | % | 2.20 |
| Total Calcium (Ca) | % | 10.7 |
| Total Magnesium (Mg) | % | 1.02 |
| Total Zinc (Zn) | ppm | 87 |
| Total Iron (Fe) | ppm | 7835 |
| Total Manganese (Mn) | ppm | 1657 |
| Total Copper (Cu) | ppm | 32 |
| Total Carbon (C) | % | 0.30 |
| Total Boron (B) | ppm | 0.759 |
| Total Sulfur (S) | % | 0.283 |
| Chloride | ppm | 525 |

[symbol]

Interpretation for nitrate-N is for growing media only. If this material is to be used as soil amendment, the interpretation for nitrate-N is not applicable. [symbol]
indicates data missing or illegible when filed

TABLE 10
effects of wood ash per ton per acre

| Lab | Sample | | N.A. meq/ | % | P Bray I | Ca | Mg | K | CEC meq/ | ZN | FE | MN | CU |
|---|---|---|---|---|---|---|---|---|---|---|---|---|---|
| Number | ID | pHs | 100 g | OM | lb/A | lb/A | lb/A | lb/A | 100 g | ppm | ppm | ppm | ppm |
| C2100677 | CONTROL | 6.1 | 1.5 | 3.5 | 64 | 5299 | 602 | 174 | 17.5 | 1.4 | 49.1 | 13.5 | 0.96 |
| C2111235 | 1 TON | 7.3 | 0 | 2.9 | 41 | 5859 | 672 | 274 | 17.8 | 1.1 | 40.2 | 7 | 0.89 |
| C2111236 | 2 TON | 7.6 | 0 | 3.2 | 52 | 9364 | 975 | 430 | 28 | 1.2 | 30.4 | 5.6 | 0.83 |
| C2111237 | 4 TON | 7.6 | 0 | 3.5 | 61 | 8815 | 911 | 633 | 26.6 | 1.3 | 20.5 | 40.1 | 0.86 |
| C2111238 | 6 TON | 7.7 | 0 | 3.2 | 56 | 9704 | 1003 | 495 | 29.1 | 1.4 | 30.9 | 7.8 | 0.95 |

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations, locations, etc. have been described for use with disclosed embodiments, others besides those disclosed may be utilized without exceeding the scope of the invention.

Persons of ordinary skill in the relevant arts will recognize that the subject matter hereof may comprise fewer features than illustrated in any of the individual embodiments described above. The embodiments described herein are not meant to be an exhaustive presentation of how the various features of the subject matter herein may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. These are only examples of what is specifically intended, and all possible combinations of numerical values between the lowest value and the highest value enumerated, are to be considered to be expressly stated in this disclosure.

As used herein, “a,” “an,” or “the” can mean one or more than one. For example, “an” image can mean a single image or a plurality of images.

The term “and/or” as used in a phrase such as “A and/or B” herein can include both A and B; A or B; A (alone); and B (alone). Likewise, the term “and/or” as used in a phrase such as “A, B, and/or C” can include at least the following embodiments: A, B, and C; A, B, or C; A or C; A or B; B or C; A and C; A and B; B and C; A (alone); B (alone); and C (alone).

Again, it will be appreciated that the nitrogen-phosphorus-potassium (N—P—K) and other levels, ratios, and percentages provided herein, including with respect to the various sources (e.g., nitrogen sources, phosphorus sources, potassium sources, sources of micronutrients, and additional sources) are provided as non-limiting examples, are approximations, and may be in a range that encompasses percentages that are greater than or less than those example percentages listed herein.

As used herein, the term “about” when referring to a measurable value such as an amount, a temporal duration, and the like, can include variations of +/−20%, more preferably +/−10%, even more preferably +1-5% from the specified value, as such variations are appropriate to reproduce the disclosed methods and systems.

As used herein, “statistical measures” can include the mean, the median, a percentile value, a variance, a standard deviation, or similar statistical measures, such as additional measures that can be derived from the above.

As used herein “color values” can include hue, saturation, lightness, red value, green value, blue value, magenta value, cyan value, yellow value, Lab space value, L*a*b* space value, or any other value derived from obtaining images from specific spectral regions, and which can involve the comparison of such values.

The constructions described in the accompanying materials and illustrated in the drawings are presented by way of example only and are not intended to limit the concepts and principles of the present invention. Thus, there has been shown, and described several embodiments of a novel invention. As is evident from the description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.” Many changes, modifications, variations, and other uses and applications of the present construction will, however, become apparent to those skilled in the art after considering the specification and the accompanying drawings. All such changes, modifications, variations, and other uses and applications which do not depart from the spirit and scope of the invention are deemed to be covered by the invention which is limited only by the claims which follow.

What is claimed is:

1. A method for forming fertilizer, the method comprising the steps of:
combining a first source of micronutrients with at least one of the following sources:
a first nitrogen source;
a first phosphorus source;
a first potassium source; and
a first additional source.

2. The method of claim 1, wherein the first source of micronutrients is derived from a combustion of a biomass feedstock via a biomass combustion system.

3. The method of claim 1, wherein the first source of micronutrients comprises at least one of: basalt rock mineral, zinc sulphate, oyster shells, poultry manure, biomass ash, wood ash, or elemental sulfur.

4. The method of claim 1, wherein the first source of micronutrients comprises biomass ash.

5. The method of claim 1, wherein the first source of micronutrients comprises wood ash.

6. The method of claim 1, wherein the first nitrogen source is at least one of: cottonseed meal, feather meal, blood meal, alfalfa meal, fish meal, crab meal, meat meal, soybean meal, neem seed meal, corn gluten, or porcine blood meal.

7. The method of claim 1, wherein the first nitrogen source is at least one of: urea, ammonium nitrate, ammonium sulphate, calcium nitrate, nitrate, ammonia, cal-nitro, anhydrous ammonia, or aqua ammonia.

8. The method of claim 1, wherein the first phosphorus source is at least one of: fishbone meal, rock phosphate, shrimp meal, seabird guano, or bone meal.

9. The method of claim 1, wherein the first phosphorus source is at least one of: diammonium phosphate, monoammonium phosphate, triple super phosphate, or super phosphate.

10. The method of claim 1, wherein the first potassium source is at least one of: langbeinite, kelp, sulphate of potash, or greensand.

11. The method of claim 1, wherein the first potassium source is at least one of: potassium nitrate, potassium chloride, or potassium sulphate.

12. The method of claim 1, wherein the first additional source is at least one of: Earthworm castings, calcium carbonate, dolomitic limestone, wood ash, gypsum, diatomaceous Earth, chicken manure, cow manure, fish emulsion, egg shells, coffee grounds, swine manure, bat guano, horse manure, sheep manure, goat manure, or biosolids.

13. The method of claim 1, wherein the first additional source is at least one of: broadcasting, banding, foliar application, drip irrigation, seed treatment, side-dressing, or control release.

14. The method of claim 1, further comprising the step of converting the fertilizer into soil.

15. A fertilizer formed by the method of claim 1.

16. The fertilizer of claim 15, wherein the fertilizer is provided in at least one of the following forms: powder, granular, or pelletized.

17. A system comprising a processor configured to combine at least two of the following to form fertilizer: a nitrogen source, a phosphorus source, a potassium source, a source of micronutrients, and an additional source.
